(19) United States
(12) Patent Application Publication
(10) Pub. No.: US 2015/0022402 A1
(43) Pub. Date: Jan. 22, 2015

(54) CAPACITIVELY COUPLED LOOP ANTENNA AND AN ELECTRONIC DEVICE INCLUDING THE SAME

(71) Applicant: Nvidia Corporation, Santa Clara, CA (US)

(72) Inventors: Joselito Gavilan, Santa Clara, CA (US); Warren Lee, Santa Clara, CA (US)

(21) Appl. No.: 13/945,106

(22) Filed: Jul. 18, 2013

(51) Int. Cl. H01Q 7/00

(52) U.S. Cl. CPC H01Q 7/00
USPC 343/702; 343/866

(57) ABSTRACT

Provided is an antenna. The antenna, in one embodiment, includes a feed element electrically connectable to a positive terminal of a transmission line, and a ground element electrically connectable to a negative terminal of the transmission line. In this embodiment of the antenna, the feed element and ground element capacitively couple to one another without touching to form a capacitively coupled loop antenna.

### CROSS-REFERENCE TO RELATED APPLICATION

This application claims the benefit of U.S. patent application Ser. No. 13/945,083, filed by Joselito Gavilan, et al., on Jun. 18, 2013, entitled “Antenna System and an Electronic Device Including the Same,” commonly assigned with this application and incorporated herein by reference.

### TECHNICAL FIELD

This application is directed, in general, to antennas and, more specifically, to antennas for handheld electronic devices.

### BACKGROUND

Handheld electronic devices are becoming increasingly popular. Examples of handheld devices include handheld computers, cellular telephones, media players, and hybrid devices that include the functionality of multiple devices of this type, among others.

Due in part to their mobile nature, handheld electronic devices are often provided with wireless communications capabilities. Handheld electronic devices may use long-range wireless communications to communicate with wireless base stations. For example, cellular telephones may communicate using 2G Global System for Mobile Communication (commonly referred to as GSM) frequency bands at about 850 MHz, 900 MHz, 1800 MHz, and 1900 MHz, among possible others. Communication is also possible in the 3G Universal Mobile Telecommunication System (commonly referred to as UMTS, and more recently HSPA+) and 4G Long Term Evolution (commonly referred to as LTE) frequency bands which range from 700 MHz to 3800 MHz. Furthermore, communications can operate on channels with variable bandwidths of 1.4 MHz to 20 MHz for LTE, as opposed to the fixed bandwidths of GSM (0.2 MHz) and UMTS (5 MHz). Handheld electronic devices may also use short-range wireless communications links. For example, handheld electronic devices may communicate using the Wi-Fi® (IEEE 802.11) bands at about 2.4 GHz and 5 GHz, and the Bluetooth® band at about 2.4 GHz. Handheld devices with Global Positioning System (GPS) capabilities receive GPS signals at about 1575 MHz.

To satisfy consumer demand for small form factor wireless devices, manufacturers are continually striving to reduce the size of components that are used in these handheld electronic devices. For example, manufacturers have made attempts to miniaturize the antennas used in handheld electronic devices. Unfortunately, doing so within the confines of the wireless device package is challenging.

Accordingly, what is needed in the art is an antenna, and associated wireless handheld electronic device, that navigate the desires and problems associated with the foregoing.

### SUMMARY

One aspect provides an antenna. The antenna, in this aspect, includes a feed element electrically connectable to a positive terminal of a transmission line, and a ground element electrically connectable to a negative terminal of the transmission line. Further to this aspect of the antenna, the feed element and ground element capacitively couple to one another without touching to form a capacitively coupled loop antenna.

Another aspect provides an electronic device. The electronic device, in this aspect, includes storage and processing circuitry, input-output devices associated with the storage and processing circuitry, and wireless communications circuitry including an antenna. The antenna, in this aspect, includes: 1) a feed element electrically connected to a positive terminal of a transmission line, and 2) a ground element electrically connected to a negative terminal of the transmission line, wherein the feed element and ground element capacitively couple to one another without touching to form a capacitively coupled loop antenna.

### BRIEF DESCRIPTION

Reference is now made to the following descriptions taken in conjunction with the accompanying drawings, in which:

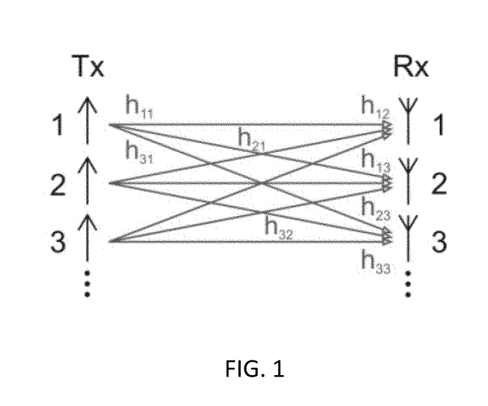

FIG. 1 illustrates aspects of a multiple-input-multiple-output (MIMO) antenna system;

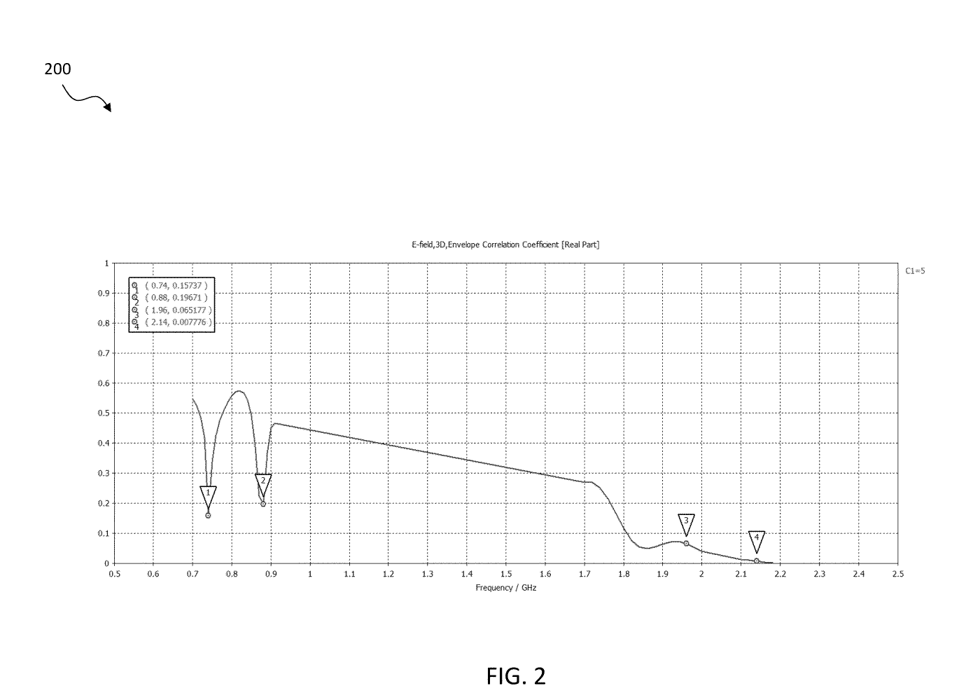

FIG. 2 illustrates a graph depicting a simulated correlation coefficient that is achievable using a MIMO antenna system, wherein the primary and secondary antennas are of different types in accordance with the disclosure;

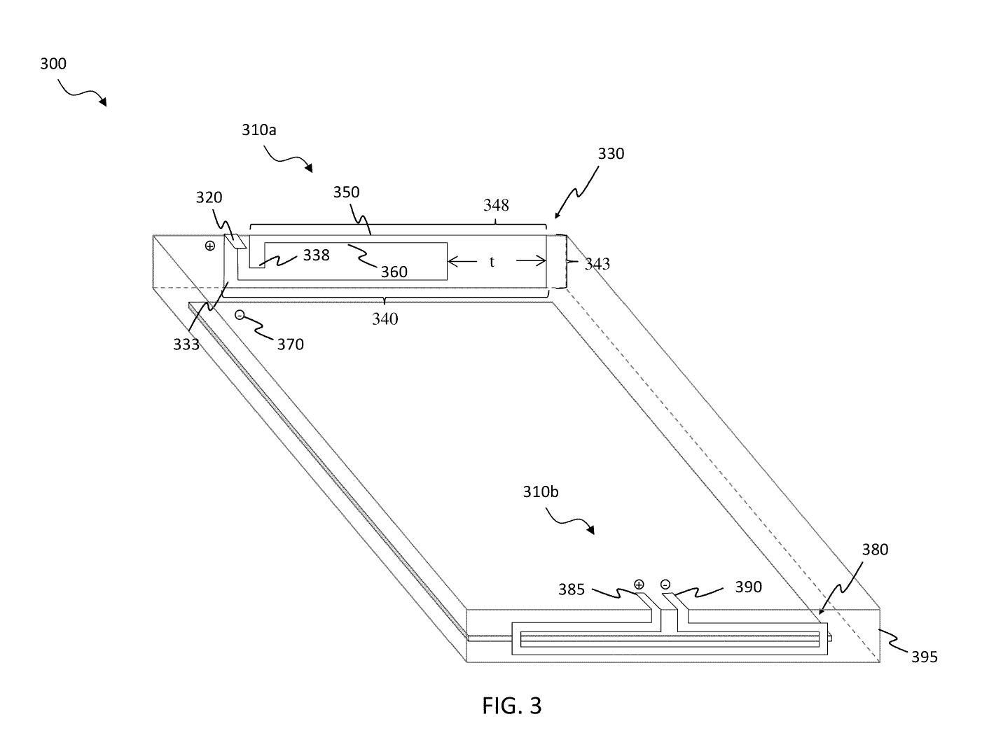

FIG. 3 illustrates aspects of a representative embodiment of an electronic device in accordance with embodiments of the disclosure;

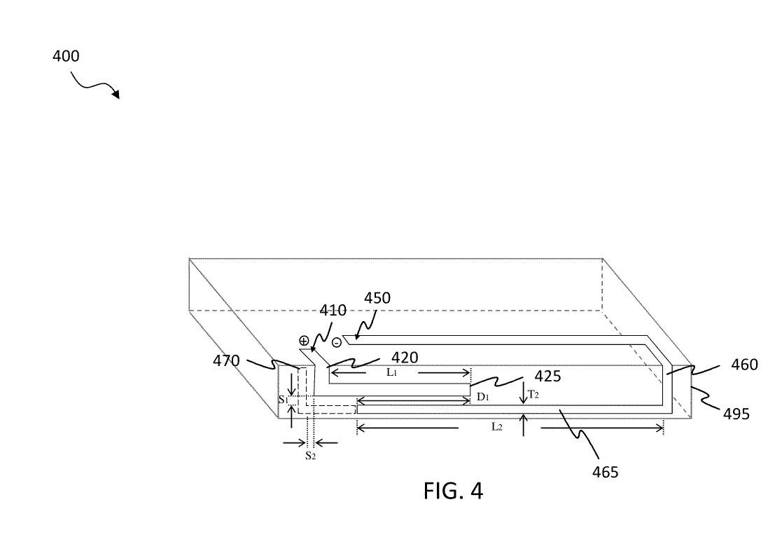

FIG. 4 illustrates an antenna manufactured and designed according to one embodiment of the disclosure;

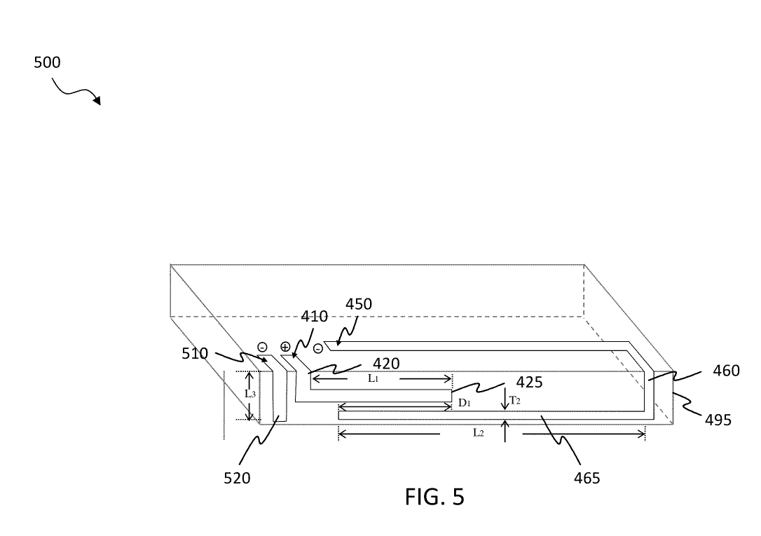

FIG. 5 illustrates alternative aspects of a representative embodiment of an antenna in accordance with embodiments of the disclosure; and

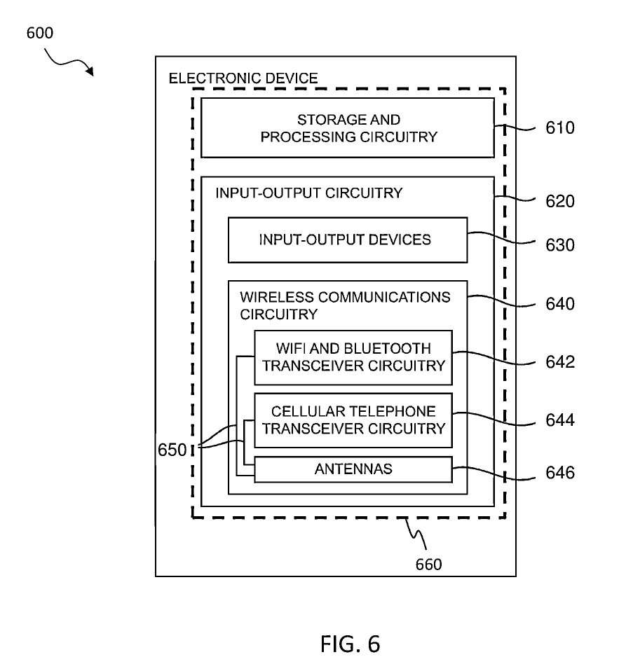

FIG. 6 illustrates a schematic diagram of electronic device in accordance with the disclosure.

### DETAILED DESCRIPTION

In modern wireless communication standards such as HSPA+ and LTE, multiple-input-multiple-output (MIMO) technology has become a vital component in the quest for better wireless performance. As shown in FIG. 1, MIMO consists of using multiple antennas at both the transmitter and receiver to improve the performance through beamforming, spatial multiplexing, and/or diversity coding. Beamforming consists of precoding the signal stream and emitting the same stream with appropriate gain/phase weighting such that the signal power is maximized at the receiver input. Spatial multiplexing splits a high data rate signal into several lower data rate streams and transmits each stream over a different antenna in the same channel, which increases the channel capacity. Diversity coding uses space-time coding to create near orthogonal copies of a single signal stream, which is transmitted over each antenna to improve the received signal strength in multi-path fading environments and achieve reliability. In all three cases, the performance improvement is generally limited by the antenna diversity and its ability to receive the separate signal streams.

With the current design trends for mobile devices such as mobile phones and tablet devices, the amount of volume available for antenna integration is limited, especially with mobile phones. A typical MIMO implementation in a mobile phone would consist of two antennas, labeled as primary and secondary. For each individual antenna, standard antenna performance metrics would apply, including antenna efficiency, directivity, and radiation pattern.

For a MIMO antenna system, the gain imbalance between the two antennas and the envelope correlation coefficient between the two antennas must be considered, in addition to the individual antenna metrics discussed above. These two relational metrics will have a direct impact on the MIMO antenna system performance. The gain imbalance is the difference of the mean gain between the two antennas in free-space. The envelope correlation coefficient determines the diversity performance and MIMO antenna system quality by taking into account the antenna radiation patterns and the propagation model of the environment. For the correlation coefficient, ρ_{c}=0 means the two antennas are completely uncorrelated and ρ_{c}=1 means the two antennas patterns are exactly the same and correlated. Recently, U.S. carriers have defined upper limits for the correlation coefficient for mobile devices implementing two antennas, as set forth in Table 1 below.

| Band (MHz) | ρ_{ε} |
|---|---|
| 700/850 | 0.5 |
| 1700/1900/2100 | 0.4 |

The present disclosure has recognized that to meet these requirements, various techniques may be used in designing the antenna pair, including spatial diversity, polarization diversity, and pattern diversity. In a handheld electronic device, the spatial and polarization diversity of the antenna designs are limited by the physical dimensions of the device. Depending on the layout of the internal components, it may not be possible to obtain polarization diversity, even by placing the two antennas on opposing edges of the chassis. In a conventional MIMO antenna system, the primary antenna is typically located in the bottom edge of the chassis and the secondary antenna is typically located in the top edge of the chassis—to maximize the spatial diversity.

The present disclosure has recognized, however, that at lower frequencies, the quarter-wavelength of the resonant frequency approaches the physical length of the chassis. For purposes of the present disclosure, the term “lower frequencies” means frequencies below about 1000 MHz (i.e., below about 1.0 GHz). Hence, for typical monopole and inverted-F antenna (IFA) antenna types, the chassis will act like a resonator for the antenna at the lower frequencies, and the antenna will be strongly coupled to the chassis resulting in poor isolation with other antennas sharing the chassis. If both antennas use the monopole and/or IFA design, the mutual coupling between the antennas will result in very high correlation coefficient values. With the deployment of HSPA+ and LTE bands (e.g., in the 700-900 MHz frequency range), the correlation coefficient limits set forth in Table 1 above become a significant challenge.

The present disclosure, with the foregoing in mind, recognized that the correlation coefficient issues may be addressed by employing two different antenna type designs for the antenna system. For example, if the primary antenna is of a monopole or IFA design, and thus is strongly coupled to the electronic device chassis (particularly as the frequency approaches 700 MHz), the secondary antenna could be of a different design (e.g., an antenna type design that is not strongly coupled to the chassis). In one embodiment, a loop antenna could be used for the secondary antenna in the MIMO antenna system, as loop antennas do not strongly couple to the chassis. In this embodiment, a loop mode resonance of the loop antenna generally contains the electric and magnetic fields within the antenna volume and concentrates the surface currents on the antenna elements, which typically decouples the loop antenna from the chassis. Accordingly, using a loop antenna design for the secondary antenna can improve the mutual coupling with the primary antenna, which as discussed above may be of a monopole or IFA design, among others.

Turning to FIG. 2, illustrated is a graph 200 depicting a simulated correlation coefficient that is achievable using a MIMO antenna system, wherein the primary and secondary antennas are of different types in accordance with the disclosure. For example, graph 200 depicts the correlation coefficient for a scenario wherein the primary antenna is a monopole antenna design and the secondary antenna is a loop type antenna design. As shown, even at 740 MHz and 880 MHz, the correlation coefficient is far below the 0.5 limit set forth by U.S. carriers, thus the radiation patterns are clearly uncorrelated.

FIG. 3 illustrates aspects of a representative embodiment of an electronic device 300 in accordance with embodiments of the disclosure. The electronic device 300, in accordance with the disclosure, includes an antenna system 310 contained within a conductive chassis 395. The antenna system 310, as is common, includes a first antenna 310a, and a second antenna 310b, both of which are operable to communicate at a given frequency (e.g., below about 1000 MHz in one embodiment). In one embodiment, for example wherein the antenna system is a MIMO antenna system, the first antenna 310a functions as the primary antenna of the antenna system 310 and the second antenna 310b functions as the secondary antenna of the antenna system 310.

In accordance with one embodiment of the disclosure, the first antenna 310a comprises an antenna type that would use the chassis 395 (whether intentionally or otherwise) as a resonator, particularly at lower frequencies. Accordingly, in this embodiment, the first antenna 310a would be strongly coupled to the chassis 395, typically resulting in poor isolation with other antennas sharing the chassis.

In one embodiment of the disclosure, the first antenna 310a comprises a monopole or IFA antenna type design, both of which typically use the conductive chassis 395 as a resonator. Nevertheless, other antenna types that use the conductive chassis 395 as a resonator are within the scope of the disclosure. Accordingly, the present disclosure should not be limited to any specific first antenna 310a design.

Nevertheless, the first antenna 310a illustrated in FIG. 3 is a multiband antenna of the monopole or IFA antenna type design. The first antenna 310a, in this embodiment, includes a feed portion 320. The feed portion 320, in this embodiment, may be that portion of the first antenna 310a that first receives radio frequency signals from one or more associated transceivers in a related electronic device. For example, the feed portion 320 might directly connect to a positive terminal of a transmission line (not shown), such as a coaxial cable, microstrip, etc., to receive radio frequency signals from associated transceivers, and provide them to the other portions of the antenna system 310. The feed portion 320 may additionally receive radio frequency signals from the other portions of the antenna system 310, and thus provide them to the associated transceivers.

Connected to the feed portion 320 in the embodiment of FIG. 3 is a conductive segment 330. The term “conductive segment”, as used herein, requires that the two ends of the conductor not close back upon themselves to form a closed loop. A closed loop, as well as a slot in a conductor, are not considered conductive segments as that term is defined herein. The conductive segment 330, in the illustrated embodiment, includes a first end 333 and a second end 338, and is formed as a partial loop. Further to the illustrative embodiment of FIG. 3, the conductive segment 330 folds back upon itself to form the partial loop. For instance, in the embodiment shown, the conductive segment 330 includes a first section 340, a second section 343 connected to the first section 340, and a third section 348 connected to the second section 343. In this embodiment, the second section 343 is shorter than, and substantially perpendicular to, the first section 340. Additionally, the third section 348 doubles back upon, and is substantially parallel to, the first section 340. This is but one embodiment of a configuration for the conductive segment 330. In another embodiment, the conductive segment 330 might take a more circular shape.

The first antenna 310a illustrated in FIG. 3, as a result of the unique design thereof, includes a first resonant portion 350 and a second resonant portion 360. The term “resonant portion”, as used herein, is intended to mean a portion of the antenna geometry that resonates at a desired band of frequencies. The first resonant portion 350, in the illustrative embodiment, includes a first length defined by an outer perimeter of the conductive segment 330. The first length, in the embodiment of FIG. 1, is defined by an outer perimeter of the first section 340, second section 343 and third section 348. The first resonant portion 350, in accordance with the disclosure, is operable to effect an antenna for communication in first band of frequencies.

The second resonant portion 360, in the illustrative embodiment, includes a second different length defined by an inner perimeter of the conductive segment 330. The second different length, in the embodiment of FIG. 3, is defined by an inner perimeter of the first section 340, second section 343 and third section 348. The second resonant portion 360, as a result of the geometry of the inner loop, includes a capacitive resonance. The term “capacitive resonance”, as used herein, is intended to mean the resonance at a desired band of frequencies due to two conductors being capacitively coupled to one another. Accordingly, the second resonant portion 360 is operable to resonate capacitively for communication in a second different band of frequencies.

In accordance with the embodiment of FIG. 3, the first length of the first resonant portion 350 or the second length of the second resonant portion 360 may be modified without modifying the other of the second length or the first length. For example, a thickness (t) of at least a portion of the conductive segment 330 may be adjusted to modify the one of the first length of the first resonant portion 350 or the second length of the second resonant portion 360 without modifying the other of the second length or the first length.

The first antenna 310a illustrated in the embodiment of FIG. 3 additionally includes a ground (e.g., ground plane) portion 370. In the illustrated embodiment, ground portion 370 might connect to a negative terminal of the transmission line (not shown), such as a coaxial cable, microstrip, etc. The ground portion 370, in accordance with one embodiment of the disclosure, may connect to or form a portion of the conductive chassis 395. Additional details for the first antenna 310a illustrated in FIG. 3 may be found in U.S. patent application Ser. No. 13/691,222, filed by Joselito Gavilan, et al., on Nov. 30, 2012, entitled “A Multi-Band Antenna and an Electronic Device Including the Same,” commonly assigned with this application and incorporated herein by reference.

In accordance with one embodiment of the disclosure, the second antenna 310b comprises an antenna type that uses the conductive chassis 395 as a resonator much less than the first antenna 310b would use the conductive chassis 395 as a resonator. Accordingly, the second antenna 310b would not strongly couple to the chassis 395 (whether intentionally or otherwise), particularly at lower frequencies. Accordingly, in accordance with the disclosure, a correlation coefficient of the first and second antennas 310a, 310b is less than about 0.5 for a given communication frequency below about 1000 MHz. In accordance with another embodiment of the disclosure, the correlation coefficient of the first and second antennas 310a, 310b is less than about 0.5 for communication frequencies ranging from about 730 MHz to about 750 MHz and about 870 MHz to about 890 MHz. This is particularly the case when a largest physical dimension of the conductive chassis 395 is about ¼ or less a wavelength of the frequencies below about 1000 MHz, including the communication frequencies ranging from about 730 MHz to about 750 MHz and about 870 MHz to about 890 MHz.

In the illustrated embodiment of FIG. 3, the second antenna 310b comprises a loop antenna. A loop antenna consists of an electrical conductor with its opposing ends connected to a balanced transmission line. Although a loop typically infers a circular shape, the electrical conductor can be oriented in any closed shape while still maintaining its characteristics. One of the main characteristics of a loop is the resonant frequency, which is determined by the circumference of the loop. The wavelength at the resonant frequency is approximately equal to the circumference of the loop, hence, the physical dimensions will increase for lower frequency bands.

In the embodiment of FIG. 3, the second antenna 310b includes a continuous conductor 380 that is physically formed into a complete loop. One end of the continuous conductor 380 connects to a feed portion 385, and the other end of the continuous conductor 380 connects to a ground portion 390. The feed portion 385, in this embodiment, may be that portion of the second antenna 310b that first receives radio frequency signals from one or more associated transceivers in a related electronic device. For example, the feed portion 385 might directly connect to a positive terminal of a transmission line (not shown), such as a coaxial cable, microstrip, etc., to receive radio frequency signals from associated transceivers, and provide them to the other portions of the antenna system 310. The feed portion 385 may additionally receive radio frequency signals from the other portions of the antenna system 310, and thus provide them to the associated transceivers.

In one embodiment, the ground portion 390 might connect to a negative terminal of the transmission line (not shown), such as a coaxial cable, microstrip, etc. The ground portion 390, in accordance with one embodiment of the disclosure, may connect to or form a portion of the ground portion 370. While not shown, the ground portion 390 may also connect to or form a portion of the conductive chassis 395.

Specific antenna type designs have been disclosed for each of the first and second antennas 310a, 310b. It should be noted that even though these specific designs have been disclosed with regard to FIG. 3, other designs, whether currently known or hereafter discovered, could be used and remain within the purview of this disclosure. For example, other monopole and/or IFA antenna designs could be used for the first antenna 310a, including other designs disclosed in U.S. patent application Ser. No. 13/691,222 discussed above, among others. Similarly, other antenna designs could be used for the second antenna 310b, such as the other designs disclosed here below (e.g., capacitively coupled loop antenna designs), among others.

Loop antenna designs, particularly at lower frequencies, tend to be quite large. Accordingly, for certain antenna applications, including antenna applications for small electronic devices (e.g., tablet computers, handheld computers, game consoles, mobile phones, etc.) operating at the lower frequencies, traditional loop antennas will not fit within the form factor (e.g., conductive chassis 395) of the handheld electronic device. The present disclosure, however, recognized for the first time that capacitively coupled loop antennas could be used in place of traditional loop antennas and more easily fit within the form factor (e.g., conductive chassis 395) of the handheld electronic device. In one aspect of the disclosure, a largest physical dimension of the conductive chassis 395 is about ¼ or less a wavelength of a given frequency below about 1000 MHz. In another aspect, the largest physical dimension of the conductive chassis 395 is about ¼ or less a wavelength of communication frequencies ranging from about 730 MHz to about 750 MHz and about 870 MHz to about 890 MHz.

Turning to FIG. 4, illustrated an antenna 400 manufactured and designed according to one embodiment of the disclosure. The antenna 400, much like a traditional loop antenna, is an antenna type that does not use the conductive chassis as a resonator. Accordingly, an antenna, such as the antenna 400 of FIG. 4, could be used as the second antenna 310b illustrated in FIG. 3 above, among other uses.

In one embodiment, the antenna 400 includes a feed element 410 and a ground element 450. For example, the feed element 410 might directly connect to a positive terminal of a transmission line (not shown), such as a coaxial cable, microstrip, etc., to receive radio frequency signals from associated transceivers. The feed element 410 may additionally receive radio frequency signals from other antennas, and thus provide them to the associated transceivers. In contrast, the ground element 450 might directly connect to a negative terminal of the transmission line (not shown). The ground element 450, in accordance with one embodiment of the disclosure, may connect to or form a portion of the conductive chassis 495.

In accordance with the disclosure, the feed element 410 and ground element 450 capacitively couple to one another (e.g., in one embodiment by at least partially overlapping) to form a capacitively coupled loop antenna. A capacitively coupled loop antenna behaves like a loop antenna but without a continuous electrical conductor. It achieves this by orienting the feed and ground elements closely spaced together and effectively closing the loop by the capacitive coupling of the arms. By utilizing capacitive coupling, the effective length of the antenna increases and the resonant frequency decreases. The amount of coupling and its impact to the effective length of the antenna can be controlled by the spacing between the arms and amount of overlap of the arms. Compared to a conventional loop antenna with similar physical dimensions, a capacitively coupled loop antenna has a lower resonant frequency.

In the embodiment of FIG. 4, the feed element 410 includes a first feed element section 420 and a second feed element section 425. Likewise, in the embodiment of FIG. 4, the ground element 450 includes a first ground element section 460 and a second ground element section 465. In the illustrated embodiment, the first and second feed element sections 420, 425 are substantially perpendicular to one another. Similarly, the first and second ground element sections 460, 465 are substantially perpendicular to one another. Likewise, in the embodiment of FIG. 4, the second feed element section 425 and second ground element section 465 are substantially parallel to one another.

In the embodiment of FIG. 4, the second feed element section 425 has a length (L₁) and second ground element section 465 has a length (L₂). In the embodiment of FIG. 4, the second feed element section 425 and second ground element section 465 at least partially overlap one another by at distance (D₁). Additionally, the second feed element section 425 and the second ground element section 465 have a minimum spacing (S₁) there between. The term minimum spacing, as used herein, is the minimum distance between the second feed element section 425 and the second ground element section 465 over the overlap distance (D₁).

The embodiment of FIG. 4 illustrates the embodiment wherein the second feed element section 425 and the second ground element section 465 overlap one another to capacitively couple. Another embodiment (not shown) may exist wherein the second feed element section 425 and the second ground element section 465 approach one another end-to-end (e.g., if they were located in a same plane). In this embodiment, the capacitive coupling would be from the ends of the second feed element section 425 and the second ground element section 465, as opposed to the overlap of the two. In one embodiment, to achieve the appropriate capacitive coupling when the second feed element section 425 and the second ground element section 465 are positioned end-to-end, an end-to-end spacing between the two should be about 10 mm or less. In another embodiment, to achieve the appropriate capacitive coupling an end-to-end spacing between the two should be about 5 mm or less, or yet even 3 mm or less.

As indicated above, the various configurations and dimensions of the feed element 410 and ground element 450 may be adjusted to tailor the resonant frequencies of the antenna 400, including the both the lower and higher band frequencies. Take for example the antenna 400 of FIG. 4, by increasing the length (L₁), and thus increasing the distance (D₁), the lower band resonant frequency would decrease and the lower band impedance loop (e.g., as represented on a smith chart) would become larger and rotate clockwise, and the higher band resonant frequency would also decrease, but the higher band impedance loop would remain about the same size and would also rotate clockwise. A decrease in the length (L₁) would typically have just the opposite effect on both the lower and higher band frequencies and impedance loops. Interestingly, the decrease in resonant frequency, respectively, for the lower and higher bands for a given change in the length (L₁) is typically not proportional.

In contrast, by decreasing the length (L₂), and thus decreasing the distance (D₁), the lower band resonant frequency would increase and the lower band impedance loop would remain the same size but rotate counter clockwise, and the higher band resonant frequency and impedance loop (e.g., both in size and rotation) would remain about the same. The increase in the length (L₂) would typically have just the opposite effect on both the lower and higher band frequencies and impedance loops. Interestingly, decreasing the length (L₂) does not have the exact same effect on the antenna 400 as decreasing the length (L₁).

In yet further contrast, by increasing the minimum spacing (S₁), the lower band resonant frequency would increase and the lower band impedance loop would reduce in size and rotate counter clockwise, and the higher band resonant frequency and impedance loop (e.g., both in size and rotation) would remain about the same. Additionally, the increase in the minimum spacing (S₁) would typically have just the opposite effect on both the lower and higher band frequencies and impedance loops.

Notwithstanding the foregoing, the distance (D₁) that the feed element 410 and ground element 450 overlap may be an important feature of the antenna 400 design. For example, in one embodiment, the distance (D₁) may be at least about ⅙ the length (L₂) of the second ground element section 465. In yet another embodiment, the distance (D₁) may be at least about ¼ the length (L₂) of the second ground element section 465. In yet another embodiment, the distance (D₁) may be at least about ⅓ the length (L₂) of the second ground element section 465. The greater overlap, at least as it relates to length (L₂) of the second ground element section 465, is particularly important in smaller electronic devices (e.g., tablet devices, mobile phones, etc.) wherein the volume to implement the antenna is greatly reduced.

Similarly, the minimum spacing (S₁) is an important feature of the antenna 400. For example, in one embodiment, the minimum spacing (S₁) between the second feed element section 425 and second ground element section 465 is less than about two times a minimum thickness (T₂) of the second ground element section 465. In yet another embodiment, the minimum spacing (S₁) between the second feed element section 425 and second ground element section 465 is less than about the minimum thickness (T₂) of the second ground element section 465. Similar to the overlap discussed above, the minimum spacing (S₁) is particularly important in smaller electronic devices (e.g., tablet devices, mobile phones, etc.) wherein the volume to implement the antenna is greatly reduced.

Returning to FIG. 4, certain embodiments may exist wherein the ground element 450 includes a third ground element section 470. The third ground element section 470, in the illustrated embodiment, is connected to the second ground element section 465, and is substantially parallel to the first ground element section 460 and substantially perpendicular to the second ground element section 465. Similarly, the third ground element section 470 is substantially parallel to the first feed element section 420, and in this embodiment, separated from the first feed element section 420 by a minimum spacing (S₂). In the illustrated embodiment, the minimum spacing (S₂) might have similar values as the minimum spacing (S₁). The third ground element section 470 may be used to increase the overlap distance (D₁), and thus increase the capacitance between the feed element 410 and ground element 450.

FIG. 5 illustrates alternative aspects of a representative embodiment of an antenna 500 in accordance with embodiments of the disclosure. Where used, like reference numerals indicate similar features to the antenna 400 of FIG. 4. In addition to many of the features of FIG. 4, the antenna 500 includes a parasitic arm 510. The parasitic arm 510, which is routed adjacent to the feed element 410, is configured to improve the bandwidth of the high band resonance. In the illustrated embodiment, the parasitic arm 510 includes a first parasitic arm section 520. The first parasitic arm section 520, in this embodiment, is substantially parallel to the first feed element section 420.

The length (L₃) of the parasitic arm 510 may be modified to help tune the resonant frequency of the antenna 400, particularly the higher band resonant frequency. For example, by increasing the length (L₃), the lower band resonant frequency and lower band impedance loop would remain about the same, but the higher band resonant frequency would slightly decrease, while the higher band impedance loop would remain about the same. Those skilled in the art, given the present disclosure, would understand the steps required to employ a parasitic arm, such as the parasitic arm 510.

FIG. 6 shows a schematic diagram of electronic device 600 manufactured in accordance with the disclosure. Electronic device 600 may be a portable device such as a mobile telephone, a mobile telephone with media player capabilities, a handheld computer, a remote control, a game player, a global positioning system (GPS) device, a laptop computer, a tablet computer, an ultraportable computer, a combination of such devices, or any other suitable portable electronic device.

As shown in FIG. 6, electronic device 600 may include storage and processing circuitry 610. Storage and processing circuitry 610 may include one or more different types of storage such as hard disk drive storage, nonvolatile memory (e.g., flash memory or other electrically-programmable-read-only memory), volatile memory (e.g., static or dynamic random-access-memory), etc. Processing circuitry in the storage and processing circuitry 610 may be used to control the operation of device 600. The processing circuitry may be based on a processor such as a microprocessor and other suitable integrated circuits. With one suitable arrangement, storage and processing circuitry 610 may be used to run software on device 600, such as internet browsing applications, voice-over-internet-protocol (VOIP) telephone call applications, email applications, media playback applications, operating system functions, etc. Storage and processing circuitry 610 may be used in implementing suitable communications protocols.

Communications protocols that may be implemented using storage and processing circuitry 610 include, without limitation, internet protocols, wireless local area network protocols (e.g., IEEE 802.11 protocols—sometimes referred to as WiFi®), protocols for other short-range wireless communications links such as the Bluetooth® protocol, protocols for handling 3G communications services (e.g., using wide band code division multiple access techniques), 2G cellular telephone communications protocols, etc. Storage and processing circuitry 610 may implement protocols to communicate using 2G cellular telephone bands at 850 MHz, 900 MHz, 1800 MHz, and 1900 MHz (e.g., the main Global System for Mobile Communications or GSM cellular telephone bands) and may implement protocols for handling 3G and 4G communications services.

Input-output device circuitry 620 may be used to allow data to be supplied to device 600 and to allow data to be provided from device 600 to external devices. Input-output devices 630 such as touch screens and other user input interfaces are examples of input-output circuitry 620. Input-output devices 630 may also include user input-output devices such as buttons, joysticks, click wheels, scrolling wheels, touch pads, key pads, keyboards, microphones, cameras, etc. A user can control the operation of device 600 by supplying commands through such user input devices. Display and audio devices may be included in devices 630 such as liquid-crystal display (LCD) screens, light-emitting diodes (LEDs), organic light-emitting diodes (OLEDs), and other components that present visual information and status data. Display and audio components in input-output devices 630 may also include audio equipment such as speakers and other devices for creating sound. If desired, input-output devices 630 may contain audio-video interface equipment such as jacks and other connectors for external headphones and monitors.

Wireless communications circuitry 640 may include radio-frequency (RF) transceiver circuitry formed from one or more integrated circuits, power amplifier circuitry, low-noise input amplifiers, passive RF components, one or more antennas, and other circuitry for handling RF wireless signals. Wireless signals can also be sent using light (e.g., using infrared communications). Wireless communications circuitry 640 may include radio-frequency transceiver circuits for handling multiple radio-frequency communications bands. For example, circuitry 640 may include transceiver circuitry 642 that handles 2.4 GHz and 5 GHz bands for WiFi® (IEEE 802.11) communications and the 2.4 GHz Bluetooth® communications band. Circuitry 640 may also include cellular telephone transceiver circuitry 644 for handling wireless communications in cellular telephone bands such as the GSM bands at 850 MHz, 900 MHz, 1800 MHz, and 1900 MHz, as well as the UMTS, HSPA+ and LTE bands (as examples). Wireless communications circuitry 640 can include circuitry for other short-range and long-range wireless links if desired. For example, wireless communications circuitry 640 may include global positioning system (GPS) receiver equipment, wireless circuitry for receiving radio and television signals, paging circuits, etc. In WiFi® and Bluetooth® links and other short-range wireless links, wireless signals are typically used to convey data over tens or hundreds of feet. In cellular telephone links and other long-range links, wireless signals are typically used to convey data over thousands of feet or miles.

Wireless communications circuitry 640 may include antennas 646. Device 600 may be provided with any suitable number of antennas. There may be, for example, one antenna, two antennas, three antennas, or more than three antennas, in device 600. For example, in one embodiment, the antennas 646 form at least a portion of a MIMO antenna system. In this embodiment, the MIMO antenna system might include a primary antenna comprising a monopole or IFA type antenna, and a secondary antenna comprising a loop type antenna, such as that discussed above with regard to FIG. 3. In another embodiment, the antennas 646 might include an antenna as discussed above with regard to FIGS. 4-5, among others. In accordance with the disclosure, the antennas may handle communications over multiple communications bands. Different types of antennas may be used for different bands and combinations of bands. For example, it may be desirable to form a multi-band antenna for forming a local wireless link antenna, a multi-band antenna for handling cellular telephone communications bands, and a single band antenna for forming a global positioning system antenna (as examples).

Paths 650, such as transmission line paths, may be used to convey radio-frequency signals between transceivers 642 and 644, and antennas 646. Radio-frequency transceivers such as radio-frequency transceivers 642 and 644 may be implemented using one or more integrated circuits and associated components (e.g., power amplifiers, switching circuits, matching network components such as discrete inductors, capacitors, and resistors, and integrated circuit filter networks, etc.). These devices may be mounted on any suitable mounting structures. With one suitable arrangement, transceiver integrated circuits may be mounted on a printed circuit board. Paths 650 may be used to interconnect the transceiver integrated circuits and other components on the printed circuit board with antenna structures in device 600. Paths 650 may include any suitable conductive pathways over which radio-frequency signals may be conveyed including transmission line path structures such as coaxial cables, microstrip transmission lines, etc.

The device 600 of FIG. 6 further includes a chassis 660. The chassis 600 may be used for mounting/supporting electronic components such as a battery, printed circuit boards containing integrated circuits and other electrical devices, etc. For example, in one embodiment, the chassis 660 positions and supports the storage and processing circuitry 510, and the input-output circuitry 620, including the input-output devices 630 and the wireless communications circuitry 640 (e.g., including the WIFI and Bluetooth transceiver circuitry 642, the cellular telephone circuitry 644, and the antennas 646.

The chassis 660, in one embodiment, is a metal chassis. For example, the chassis 660 may be made of various different metals, such as aluminum. Chassis 660 may be machined or cast out of a single piece of material, such as aluminum. Other methods, however, may additionally be used to form the chassis 660. In certain embodiments, the chassis 660 will act like a resonator for certain ones of the antennas 646, and will not act as a resonator for other ones of the antennas 646—particularly at lower operating frequencies.

Those skilled in the art to which this application relates will appreciate that other and further additions, deletions, substitutions and modifications may be made to the described embodiments.

What is claimed is:

1. An antenna, comprising:
a feed element electrically connectable to a positive terminal of a transmission line; and
a ground element electrically connectable to a negative terminal of the transmission line, wherein the feed element and ground element capacitively couple to one another without touching to form a capacitively coupled loop antenna.

2. The antenna of claim 1, wherein the feed element is connected to the positive terminal and the ground element is connected to the negative terminal, and further wherein the feed element includes a first feed element section and a second feed element section connected to the first feed element section.

3. The antenna of claim 2, wherein the first and second feed element sections are substantially perpendicular to one another.

4. The antenna of claim 2, wherein the ground element includes a first ground element section and a second ground element section connected to the first ground element section.

5. The antenna of claim 4, wherein the first and second ground element sections are substantially perpendicular to one another.

6. The antenna of claim 5, wherein the ground element further includes a third ground element section connected to the second ground element section, wherein the third ground element section is substantially parallel to the first ground element section and substantially perpendicular to the second ground element section.

7. The antenna of claim 4, wherein the second feed element section and second ground element section at least partially overlap one another by a distance (D₁).

8. The antenna of claim 7, wherein the second feed element section has a length (L₁) and the second ground element section has a length (L₂), and further wherein the distance (D₁) is at least about ⅙ the length (L₂).

9. The antenna of claim 8, wherein the distance (D₁) is at least about ¼ the length (L₂).

10. The antenna of claim 8, wherein the distance (D₁) is at least about ⅓ the length (L₂).

11. The antenna of claim 4, further including a parasitic element electrically connected to the negative terminal of the transmission line.

12. The antenna of claim 11, wherein the parasitic element has a parasitic element section positioned substantially parallel to the first ground element section and substantially perpendicular to the second ground element section.

13. The antenna of claim 4, wherein a minimum spacing (S₁) between the second feed element section and second ground element section is less than about two times a minimum thickness (T₂) of the second ground element section.

14. The antenna of claim 13, wherein the minimum spacing (S₁) is less than the minimum thickness (T₂) of the second ground element section.

15. An electronic device, comprising:
storage and processing circuitry;
input-output devices associated with the storage and processing circuitry; and
wireless communications circuitry including an antenna, the antenna including;
a feed element electrically connected to a positive terminal of a transmission line; and
a ground element electrically connected to a negative terminal of the transmission line, wherein the feed element and ground element capacitively couple to one another without touching to form a capacitively coupled loop antenna.

16. The electronic device of claim 15, wherein the feed element includes a first feed element section and a second feed element section connected to the first feed element section, and the ground element includes a first ground element section and a second ground element section connected to the first ground element section.

17. The electronic device of claim 16, wherein the first and second feed element sections are substantially perpendicular to one another, the first and second ground element sections are substantially perpendicular to one another, and the second feed element and second ground element are substantially perpendicular to one another.

18. The electronic device of claim 16, wherein the second feed element section and second ground element section at least partially overlap one another by a distance (D₁), wherein the second feed element section has a length (L₁) and the second ground element section has a length (L₂), and further wherein the distance (D₁) is at least about ⅙ the length (L₂).

19. The electronic device of claim 16, wherein a minimum spacing (S₁) between the second feed element section and second ground element section is less than a minimum thickness (T₂) of the second ground element section.

20. The electronic device of claim 15, wherein the storage and processing circuitry, input-output devices, and wireless communications circuitry are positioned within a conductive chassis, and further wherein the ground element is connected to the conductive chassis.
